(19) United States
(12) Patent Application Publication
(10) Pub. No.: US 2010/0322738 A1
(43) Pub. Date: Dec. 23, 2010

(54) FASTENING APPARATUS

(75) Inventor: Choon-Tyng Lau, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/564,928

(22) Filed: Sep. 23, 2009

(30) Foreign Application Priority Data
Jun. 17, 2009 (CN) 200910303337.9

(51) Int. Cl. F16B 13/06

(52) U.S. Cl. 411/17

(57) ABSTRACT

A fastening apparatus is provided to secure a first component to a second component. The fastening apparatus includes a fastening anchor and a securing member. The fastening anchor includes two separated securing parts defining internal screw thread and external screw thread. The securing member defines external screw thread. The securing member is accommodated into the fastening anchor by the securing member external screw thread engaging the fastening anchor internal screw thread, and the two separated securing parts of the fastening anchor is urged to expand outward to engage with one of the first component and the second component.

### BACKGROUND

1. Technical Field

The present disclosure relates to fastening apparatuses.

2. Description of Related Art

Fastening apparatuses are usually used to secure two or more components together. A typical fastening apparatus is composed by a male member, such as a screw, and a female member, such as a screw hole. Generally, the male screw includes a head and a threaded body. The female screw defines a threaded hole.

A first component defines a first hole; a second component defines a screw hole. In use, the male screw shaft inserts through the first hole and the screw hole. The male screw head abuts the first component. The male screw external screw thread engages the female screw thread to secure the first component to the second component. However, during manufacturing it is inconvenient and costly to create the female screw threads in the second component. Therefore there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a fastening apparatus and two components.

FIG. 2 is an enlarged view of a fastening anchor of the fastening apparatus.

FIG. 3 is an assemble view of FIG. 1.

FIG. 4 is a cross-section view along IV-IV in FIG. 3.

### DETAILED DESCRIPTION

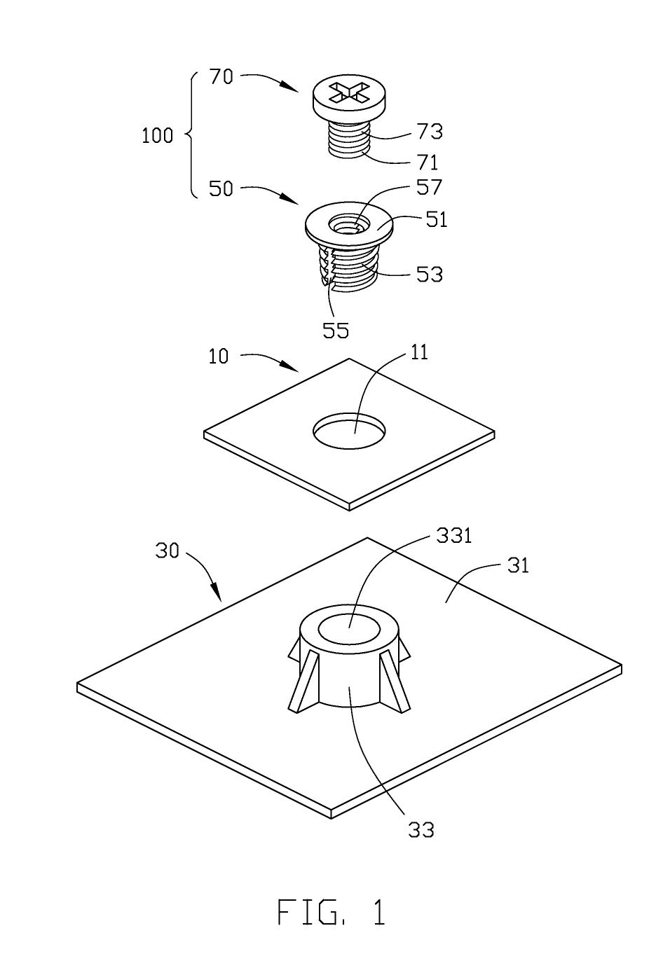

Referring to FIG. 1, a fastening apparatus 100 is provided for securing a first component 10 to a second component 30. The first component 10 may be a printed circuit board, and the second component 30 may be a computer chassis, for example. The first component 10 defines a first securing hole 11. The second component 30 includes a base 31. A securing post 33 protrudes from the base 31. The securing post 33 defines a second securing hole 331 corresponding to the first securing hole 11 in the first component 10. An embodiment of the fastening apparatus 100 includes a fastening anchor 50 and a securing member 70.

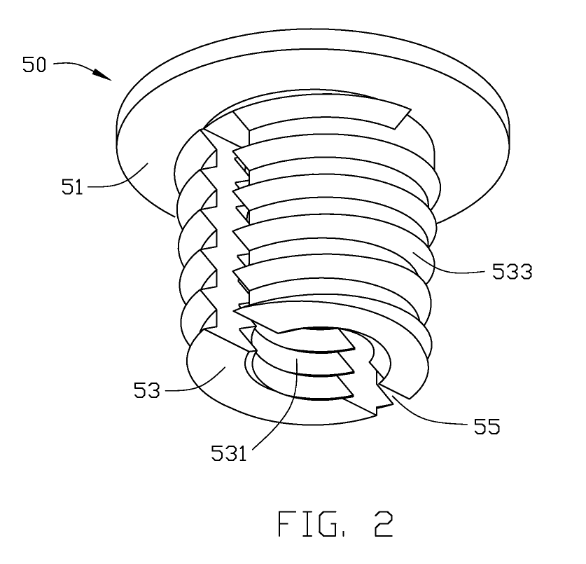

Referring also to FIG. 2, the fastening anchor 50 is a split shank screw, and includes a head 51. A diameter of the head 51 is greater than that of the first securing hole 11 in the first component 10. Two arc-shaped securing parts 53 extend from a bottom of the head 51. The two securing parts 53 cooperatively define a cylindrical profile. Two slots 55 are defined in the cylinder profile along an axial direction to separate the two securing parts 53. The two securing parts are symmetric about a radial direction of the cylinder profile defined by the two slots 55. A threaded hole 57 is defined through a cylindrical center of the fastening anchor 50. The fastening anchor 50 defines internal screw thread 531 in inner surfaces of the two securing parts 53, and defines external screw thread 533 in the cylindrical profile. A pitch diameter of the internal screw thread 531 adjacent to the head 51 is greater than a pitch diameter of the internal screw thread 531 away from the head 51. A major diameter of the external screw thread 533 adjacent to the head 51 is substantially equal to a diameter of the second securing hole 331 of the second component securing post 33.

The securing member 70 is a screw/bolt, which includes a shaft 71. The shaft 71 defines external screw thread 73 corresponding to the internal screw thread 531 of the fastening anchor 50. A pitch diameter of the securing member external screw thread 73 is greater than the pitch diameter of the fastening anchor internal screw thread 31 away from the head 51 and substantially equal to the pitch diameter of the fastening anchor internal screw thread 31 adjacent to the head 51. The head of the screw is a pan head defining a cross head drive.

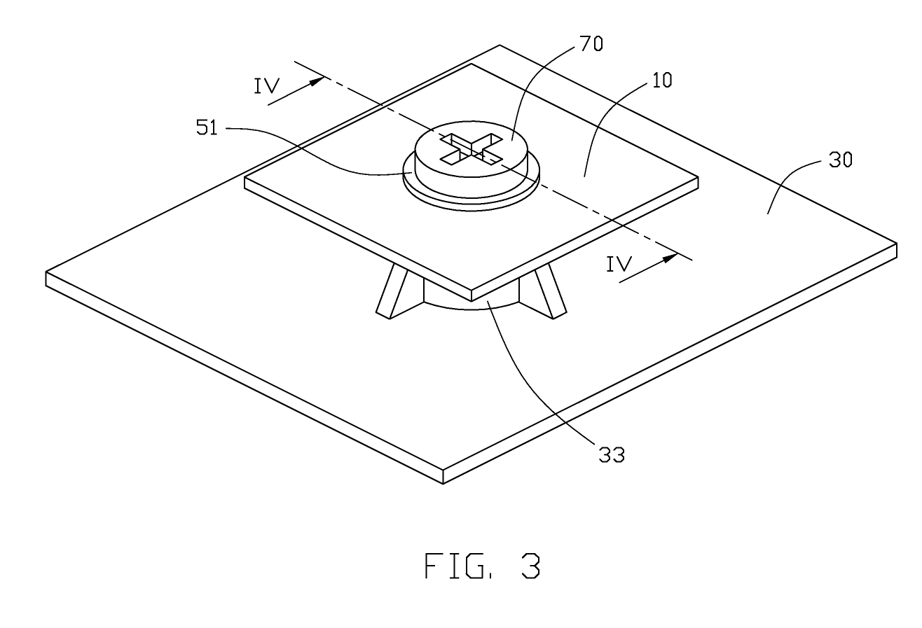

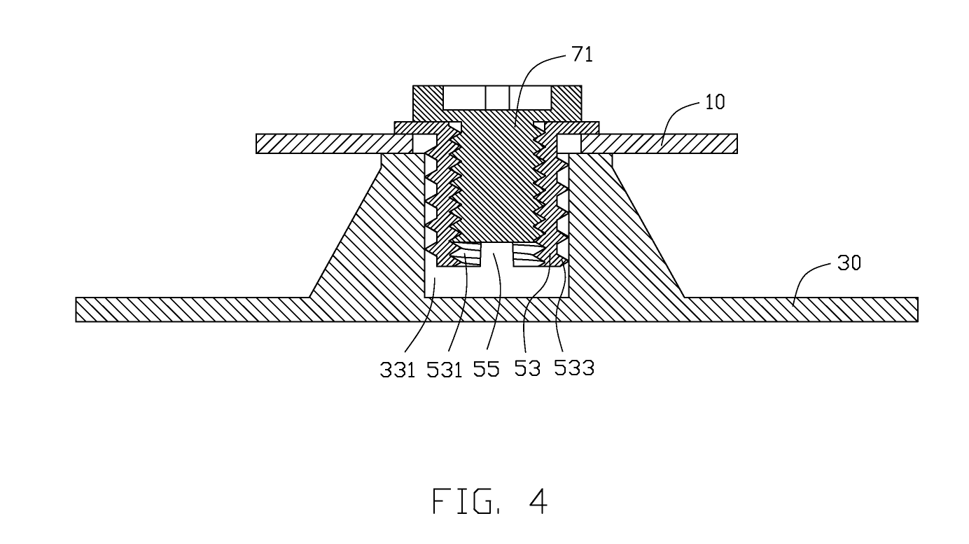

Referring to FIGS. 3 and 4, when the fastening apparatus 100 is used to secure the first component 10 to the second component 30, the first securing hole 11 in the first component 10 is aligned with the second securing hole 331 of the second component 30. The fastening anchor 50 extends through the first securing hole 11 and into the second securing hole 331. The head 51 of the fastening anchor 50 abuts on the first component 10. Then, the securing member 70 inserts in the accommodating hole 57 in the fastening anchor 50. The securing member external screw thread 73 rotatably engages the fastening anchor internal screw thread 531 and gradually urges the two securing parts 53 of the fastening anchor 50 to expand outward, so that the fastening anchor external screw thread 533 catches an inner surface of the securing post 33 of the second component 30. Thus, the first component 10 is secured to the second component 30.

It is to be understood, however, that even though numerous characteristics and advantages of the embodiments have been set forth in the foregoing description, together with details of the structure and function of the present disclosure, the disclosure is illustrative only, and changes may be made in detail, especially in matters of shape, size, and arrangement of parts within the principles of the embodiments to the full extent indicated by the broad general meaning of the terms in which the appended claims are expressed.

1. A fastening apparatus configured to secure a first component to a second component, comprising:
a fastening anchor comprising a head and a cylindric external profile, two opposite slots extend from an end adjacent to the head to the other end, the two opposite slots located on opposite sides of the cylindric external profile, to define two separated securing parts, the two securing part defining internal screw thread and external screw thread; and
a securing member defining external screw thread, the securing member being accommodated into the fastening anchor by the securing member external screw thread engaging the fastening anchor internal screw thread, and the two separated securing parts of the fastening anchor being urged to expand outward for engaging with one of the first component or the second component.

2. The fastening apparatus of claim 1, wherein the two slots are defined in the cylindric profile along an axial direction to separate the two securing parts.

3. The fastening apparatus of claim 2, wherein the two securing parts are symmetric about a radial direction of the cylindric profile defined by the two slots.

4. The fastening apparatus of claim 1, wherein the head is configured to abut the other of the first component or the second component correspondingly.

5. The fastening apparatus of claim 4, wherein a pitch diameter of internal screw thread adjacent to the head is greater than a pitch diameter of the internal screw thread away from the head.

6. The fastening apparatus of claim 5, wherein a pitch diameter of the securing member external screw thread is greater than a pitch diameter of the internal screw thread away from the head and substantially equal to a pitch diameter of the fastening anchor internal screw thread adjacent to the head.

7. A fastening apparatus configured to secure a first component to a second component, comprising:
a fastening anchor having a head and two symmetric securing parts connected to the head, the two securing parts cooperatively defining a cylindric external profile, and the cylindric external profile defines an internal screw thread; and
a securing member accommodated between the fastening anchor two securing parts, the securing member defining external screw thread;
wherein the securing member external screw thread engages with the fastening anchor internal screw thread, so as to have the securing member engaging with the fastening anchor, and to urge the two securing parts of the fastening anchor to expand outward.

8. The fastening apparatus of claim 7, wherein two slots are defined in the cylindric external profile along an axial direction to separate the two securing parts.

9. The fastening apparatus of claim 8, wherein the two securing parts are symmetric about a radial direction defined by the two slots.

10. The fastening apparatus of claim 7, wherein the cylindric external profile of the fastening anchor defines external screw thread, the head is configured to abut one of the first component or the second component, and the fastening anchor external screw thread is configured to engage with the other of the first component or the second component correspondingly.

11. The fastening apparatus of claim 10, wherein a pitch diameter of the external screw thread adjacent to the head is greater than a pitch diameter of the external screw away from the head.

12. The fastening apparatus of claim 11, wherein a pitch diameter of the securing member external screw thread is greater than a pitch diameter of the internal screw thread away from the head and substantially equal to a pitch diameter of the fastening anchor internal screw thread adjacent to the head.
